(19) United States
(12) Patent Application Publication
(10) Pub. No.: US 2003/0097568 A1
(43) Pub. Date: May 22, 2003

(54) Watermaking system and method for protecting a digital image from forgery or alteration

(76) Inventors: Jong-Uk Choi, Dobong-gu Seoul (KR); Won-Ha Lee, Dongdaemun-gu (KR)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/169,178

(22) PCT Filed: Nov. 2, 2001
(86) PCT No.: PCT/KR01/01861

(30) Foreign Application Priority Data
Nov. 2, 2000 (KR) 200064767

(51) Int. Cl. H04L 9/00

(52) U.S. Cl. 713/176

(57) ABSTRACT

The present invention provides a system and method for finding exact area of forged or altered data in a watermarked image. A watermarked image is generated in such manner that each pixel value in the original image is adjusted to a predetermined level; first watermark keys to be embedded, said keys corresponding to each pixel, are generated based on predetermined user key data; a watermark is embedded by selectively adding or subtracting a predetermined value to or from each pixel value according to the first watermark key corresponding each pixel. The forged or altered data is found by such method that a second watermark key is generated based on the user key data; the first watermark key is extracted from the watermarked image; and the co-relation between the corresponding watermarks in these watermark keys is calculated. Corresponding watermark keys are compared in every pixel.

### BACKGROUND OF THE INVENTION

1. Field of the Invention

The present invention relates to a digital image watermarking apparatus and method, more particularly, to a digital image watermarking apparatus and method for finding the exact area of a forged or altered data.

2. Description of Prior Art

As the creation and distribution of the digital image media, still images such as digital photos or moving pictures such as animation, are rapidly increased, the digital image media are commonly distributed over various storage media or network, causing illegal coping or alteration of the image media. In order to prevent such illegal coping or alteration of the digital image media, there has been developed a watermarking technique. The watermarking technique is such that additional information imperceptible to the human eye is embedded into copyrighted digital data to prevent the copyrighted digital data from being copied, distributed, altered or sold without its copyright owner's permission.

Further, the watermarking technique is to protect the integrity of digital information. For such purpose, there is provided a method that defines data for integrity in a database and senses the forgery or alteration of the data defined. This method protects the integrity of the data based on a series of rules previously defined by a manager of the database or a developer of applied program in a DataBase Management System (DBMS). However, it has a disadvantage not to ensure that the data outputted is the same as the original data since this method compulsorily executes the rules previously defined.

Further, for protection of the integrity of the data, there is provided a method using a hash function. As is generally known, as the hash function is a one-way function that maps an arbitrary length of messages to a fixed short length, the hash values are transmitted together with information concerned when transmitting the information. Thus, this method is often used to check problems such as modification and embedment of information by a third party, which may occur during the transmission of information. Also, it is possible to confirm the integrity of the main data by using the hash values as calculated, the hash values being calculated in regard to the file when storing a data file. However, after a single image data is first generated, when such the single image data is transmitted to other users through a network after its first generation, a user who finally receives the data has a difficulty in determining whether the received data is the same as the original.

Also, an apparatus and method for embedding a watermark by transforming the frequency characteristics of the original image is disclosed by Korean Patent Application No. 10-2000-53755 pending in the Korean Intellectual Property Office (KIPO), of which applicant is the same as that of the present invention. According to such conventional apparatus, with a watermark embedded in the original image data, it is possible to detect whether there has been any forgery or alteration of the original image and identify a user who uses the relevant watermark. However, it is difficult to detect the exact location of forged or altered data from the original image since such apparatus applies the frequency transformation to all data of the original image. Especially, in the case of a medical-related system, it is considerably important to guarantee the original with respect to the original medical image as photographed by its relevant system. Thus, there has been a need for a system capable of finding the exact area of forged or altered data as well as the forgery or alteration in the original image.

### SUMMARY OF THE INVENTION

It is therefore a main object of the present invention to provide a digital image watermarking system and method, which exactly detects the location of forged or altered data from an original image by properly adjusting the pixel values of the original digital image data in a spatial domain and embedding a watermark into the adjusted image data.

To achieve the above-mentioned purpose, according to a method for finding the area of forged or altered data from a watermarked image, into which a watermark is embedded, of the preferred embodiments of the present invention, a digital image is first transformed to a predetermined format for embedding a watermark. The pixel values of the transformed digital image are adjusted to a predetermined level. After making a space for embedding the watermark, first watermark keys are generated based on a predetermined user key data so that the first watermark keys are corresponded, respectively, to each of the pixel values of the image with said space for embedding the watermark. Depending on the generated first watermark keys, predetermined values are selectively added to or subtracted from each pixel value of said digital image adjusted with the predetermined level, thereafter, a watermark is embedded into said digital image. Then, the first watermark key is extracted from the watermarked digital image according to the pixel values of the watermarked digital image. Based on the predetermined user key data used when watermarking, second watermark keys are generated so that they correspond to the pixel values of the watermarked digital image. After calculating the co-relation between the first watermark key and the second watermark key in every pixel of the watermarked digital image, it is determined whether the calculated co-relation falls within a predetermined scope. If the co-relation with respect to said pixel falls within the predetermined scope, a watermark expected by a user is determined to be embedded in each pixel of the digital image. After comparing the first watermark key with the second watermark key in every pixel, if there exists a pair of inconsistent watermark keys, the corresponding pixel values of said digital image, into which the corresponding watermark is embedded, are determined to be forged or altered. In this case, the location of the forged or altered pixel values is indicated; however, if not, the corresponding pixel values are outputted as data authenticated and then detected.

These and other objects, features and advantages of the present invention will become more apparent in light of the following detailed description of the preferred embodiments thereof, with reference to the accompanying drawings.

### BRIEF DESCRIPTION OF THE DRAWINGS

FIG. 1 is a schematic block diagram showing a digital image watermarking system for embedding a watermark into digital image data according to a preferred embodiment of the present invention.

FIG. 2 is a schematic block diagram showing a digital image watermarking system for finding the area of forged or altered data with respect to the digital image acquired by the image examination equipment according to a preferred embodiment of the present invention.

FIG. 3 is a flowchart illustrating a process for detecting whether digital image data is forged or altered according to a preferred embodiment of the present invention.

FIG. 4(a) is a schematic diagram showing digital image data acquired by the image examination equipment.

FIG. 4(b) is a schematic diagram showing watermarked digital image data according to a preferred embodiment of the present invention.

FIG. 4(c) is a schematic diagram illustrating a forged or altered portion in a digital image.

FIG. 4(d) is a schematic diagram indicating the exact location of forged or altered data detected by applying a system of the present invention to digital image data.

### DETAILED DESCRIPTION OF THE INVENTION

In case where a part or all of image data, such as examined image data being transmitted via a Picture Archiving Communication System (PACS), is forged or altered, a digital image watermarking system according to the present invention is able to provide a user with the exact area of forged or altered data after finding it. As is commonly known, the PACS system is an integrated processing system of all functions necessary for making a database, transmitting or searching the diagnostic images in a digital form, which are acquired from medical imaging equipment, such as Computer Tomography (CT), Magnetic Resonance Imaging (MRI), X-ray system, or ultrasound diagnostic equipment.

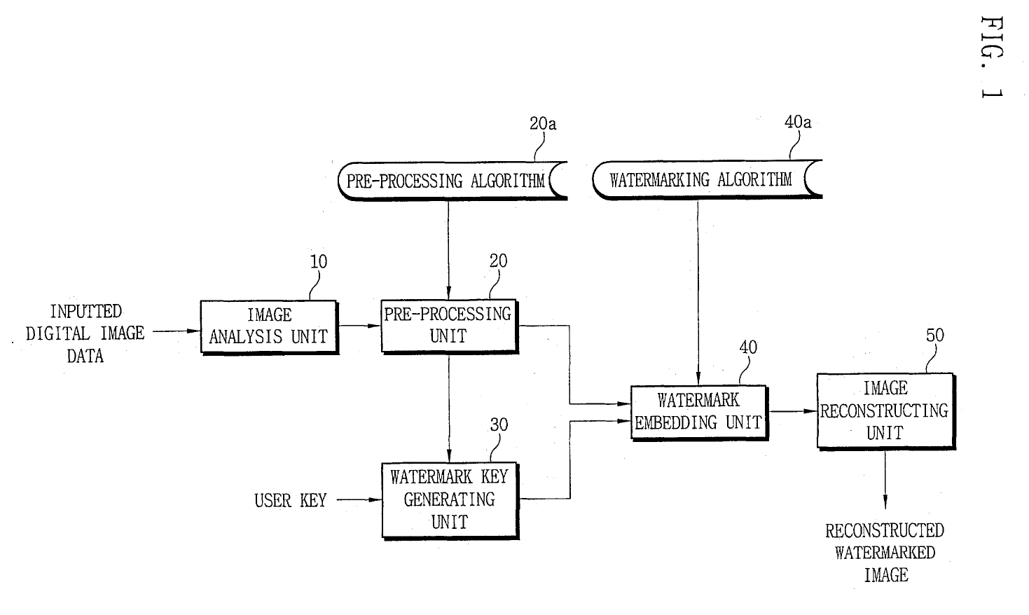

FIG. 1 is a schematic block diagram showing a digital image watermarking system for embedding a watermark into digital image data according to a preferred embodiment of the present invention.

In FIG. 1, the digital image data to be inputted is acquired from the medical imaging equipment (not shown) and inputted into an image analysis unit 10.

The analysis unit 10 analyzes the format of the inputted digital image data acquired from the medical imaging equipment, transforms the analyzed image data to a format suitable for the system of the present invention, and then transmits the transformed image data to a pre-processing unit 20. Generally, the standard DICOM (Digital Image and Communication in Medicine) 3.0 is used for the format of medical image data.

The pre-processing unit 20 adjusts digital image data to the value of a certain level to form a space, into which a watermark would be embedded, without deteriorating the quality of the digital data. Here, forming the space capable of being embedded the watermark means that the pixel values are previously adjusted to become such values that are always come under the predetermined effective scope even after the watermark is embedded. For example, when a pixel value is represented as an integer in the range of 0˜255, if +1 is added to a pixel during a watermarking process, the pixel of which original value is 255 would exceed the range of the pixel value defined. Accordingly, in this case, the pixel value should be previously adjusted to a value below 254.

To be more particular, in case that the minimum pixel value and the maximum pixel value are on a gray level of 0˜255 in the inputted digital image, a user is allowed to establish the minimum pixel value and/or maximum pixel value, for example, 1 and/or 254, without deteriorating the quality of image.

The image data pre-processed by the pre-processing Unit 20 is transmitted to a watermark embedding unit 40. The pre-processing unit 20 also transmits the information on the size of the digital image data to be inputted to a watermark key generating unit 30.

The watermark key generating unit 30 generates a watermark key, which would be used in embedding a watermark into the preprocessed image data, in accordance with the size of the preprocessed image data (i.e., inputted digital image data) on the basis of the predetermined user key data. The user key data is inputted by a user, who has a certain right on the information on size and the image transmitted from the pre-processing unit 20. The user key data indicates the private information, such as identification number, name, inherent number and the like, on a user or manager who transmits the image data to the PACS. Also, the input to the watermark key generating unit 30 can be a user's logo data or any data file to be protected.

Further, the watermark key generating unit 30 is able to encrypt the inputted user key data and generate a watermark to be embedded to the digital image data by using the encrypted key data. The encrypted user key data makes it possible to hide a user key itself without easily transforming the value of the user key. Thus, if a watermark generated from the encrypted user key is embedded into a digital image, it is advantageous that there is no concern about disclosure of the user key itself when extracting the embedded watermark from the digital image afterward. The performance of the encryption is possible by general encryption methods such as DES (Data Encryption Standard), RSA (Ronald Rivest, Adi Shamir, Leonard Adelman), ECC (Error Correction Code), etc.

For example, in case that the size of inputted digital image data is 256×256, the watermark key generating unit 30 generates a watermark key of the same 256×256 size. The watermark key generated by the watermark key generating unit 30 is transmitted to a watermark embedding unit 40.

The watermark embedding unit 40 embeds a watermark using a watermark key inputted from the watermark key generating unit 30 into the pre-processed digital image data inputted from the pre-processing unit 20 by using a watermarking algorithm 40a. A watermark embedding method according to one embodiment of the present invention is such that by selectively adding or subtracting a predetermined value (e.g., 1 or −1) to or from the pixel values, it makes its resultant value satisfied the predetermined rules determined according to a watermark key per pixel. Thus, a pixel that does not meet the rules determined according to the watermark keys is determined forged or altered.

The following serves as an example of the rules for embedding a watermark in the watermark embedding unit 40. There is made a rule that a watermark key corresponding to each pixel has either a value A or value B, and so if the watermark key has the value A, then the final result value is adjusted to odd numbers; however, if the value B, to even numbers. For example, if the original pixel value is an even number “100” and its watermarking key has the value A, “1” is added to or subtracted from the original pixel so as to make it the odd pixel value “101” or “99”. If the original pixel value is an odd number “101” and its watermarking key has the value A, the original pixel value is maintained as is. Likewise, if the original pixel value is an even number “100” and its watermarking key has the value B, the original pixel value is maintained as is. However, if the original pixel value is an odd number “101” and its watermarking key has the value B, “1” is added to or subtracted from the original pixel value to make it an even pixel value “100” or “102”.

As described above, the watermarking operation for the pixel values of the pre-processed image data may be directly performed. However, in another embodiment of the present invention, it is possible to embed a watermark by using the values, which represent the statistical properties of neighboring multiple pixel values falling within a predetermined scope around an arbitrary pixel, rather than using the pixel values. For example, a predetermined region adjacent to a pixel in an arbitrary location is established to find both the mean value of the pixels included in such predetermined region and the desired mean value of the pixel values after being watermarked from the user key data in such predetermined region. Then, the difference between both mean values is calculated, certain values are added to or subtracted from each pixel in the predetermined region in order for the mean value of the pixels in the predetermined region of the inputted digital image to be matched up to the desired mean value, thereby enabling the embedment of a watermark. Also, in addition to the mean value, there can be used various statistic characteristic values, such as the mean value +(or −) the standard deviation, variance, etc., when watermarking.

The present invention uses so-called “a fragile watermarking method”. According to this method, even a little change of its relevant pixel value results in sensitively changing a watermark key used in embedding a watermark since a predetermined value, which is added to or subtracted from an original pixel value according to a watermark key, is a very small value as compared to the original pixel value. Thus, this method makes it possible to easily sense the forgery or alteration of the original image data.

Up to now, there is explained the embedment of a watermark of every pixel into the image data, however, it is possible to embed a watermark of a block unit into the image data by the same method.

According to the present invention, the embedment of a watermark into the image data, having little effect on the quality of the image data, is possible in a spatial domain. Thus, the present invention is suitable for such PACS system that requires the high-speed processing, high quality of image, and confidence. Watermarked image data generated by the watermark embedding unit 40 is supplied to an image reconstruction unit 50.

The image reconstruction unit 50 reconstructs the watermarked image data inputted from the watermarking embedding unit 40 to the original file form (DICOM or self-format image provided by a company) so as to output the reconstructed watermark embedding image data.

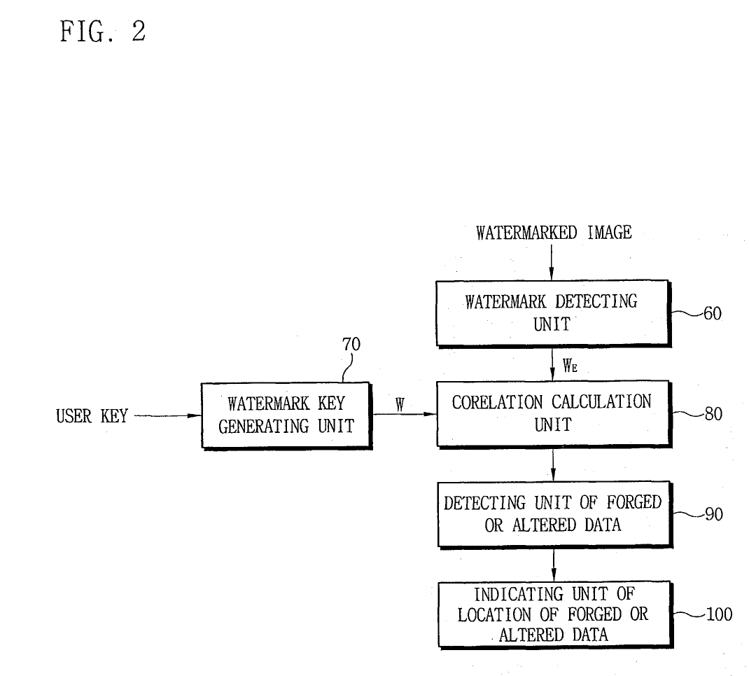

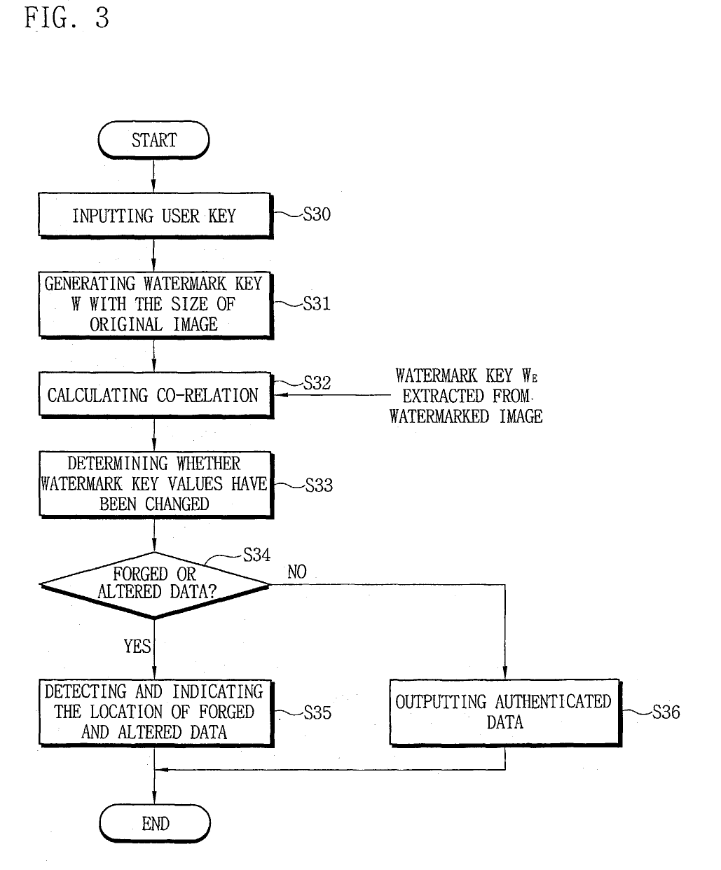

FIGS. 2 and 3 illustrate, respectively, a schematic block diagram and a flowchart of a digital image watermarking system for finding the area of the forged or altered data against the original image data acquired by the medical imaging equipment according to a preferred embodiment of the present invention.

In FIG. 2, a watermark extracting unit 60 finds, for example, a watermark key value of each pixel depending on whether the inputted pixel values are odd numbers or even numbers, and then extracts a watermark key WE from the watermark embedding image. The watermark key WE extracted is transmitted to a co-relation calculation unit 80.

In FIGS. 2 and 3, the watermark key generating unit 70 performs the same function as that of the watermark key generating unit 30 of FIG. 1 while it generates the watermark key W on the basis of user key data or logo data inputted by a user having a certain right (S30 and S31). Also, the watermark key generating unit 70 can generate a watermark by using encrypted key data made by encrypting the user key data as described above. The watermark key W generated by the watermark key generating unit 70 is transmitted to a co-relation calculation unit 80.

The co-relation calculation unit 80 finds the co-relation between a watermark key extracted from the image and a watermark key generated by a user and then first determines whether a watermark expected by the user is embedded into the inputted image. That is, in case where the co-relation between the watermark key generated by the user and that extracted from the inputted image exceeds a predetermined range, it is determined that the same watermark is embedded into the inputted image. However, if the co-relation is remarkably below the predetermined range, the watermark expected by the user is determined not to be embedded into the inputted image. In the latter case, since the watermark is not properly embedded into the inputted image, the process for determining the forgery or alteration of the image with respect to every pixel is meaningless.

Explaining in more detail, as disclosed by Korean Patent Application No. 10-2000-53755 pending in the KIPO in the name of the same applicant as that of the present invention, the co-relation calculation unit 80 calculates the co-relation between the watermark key WE extracted from the watermark extracting unit 60 and the watermark key W generated from the watermark key generating unit 70 by using the following formula (1) (S32).

Corr(W_{E},W)=real(IFFT(FFT(W)×{overscore (FFT(W)}_{E}))) [Mathematical formula 1]

Here, \overline{FFT} represents a complex conjugate of Fourier Transform (FFW) and IFFT(W) represents the reverse FFT(W).

The co-relation calculation unit 80 determines whether a watermark is embedded through the location data of the maximum value of the watermark co-relation value found by the above formula (1) or Kurtosis, the 4th order moment. The detailed explanation thereof is disclosed in Korean Patent Application No. 10-2000-53755 pending in the KIPO in the name of the same applicant as that of the present invention. If a watermark is determined to be embedded, the co-relation calculation unit 80 transmits watermark key W and W_{E} of the corresponding pixels to a detecting unit of forged or altered data 90.

The detecting unit of forged or altered data 90 compares the inputted two watermark keys W and W_{E} and then determines whether the corresponding pixel values in the original image are forged or altered (S34). If these watermark key values do not coincide with those of the original image, the detecting unit of forged or altered data 90 determines that the corresponding pixels of the original image are forged or altered. Then, the detecting unit of forged or altered data 90 masks the corresponding pixel values into black or white and indicates them as shown in FIG. 3(d) (S35). The image data from which the forged or altered area F is found is restored to the original file form (i.e., DICOM or a self-format image provided by a company and thus is allowed to be transmitted to the PACS system. Meanwhile, in case that watermark key values coincide with their corresponding pixel values in every pixel, the detecting unit of forged or altered data 90 determines that the corresponding pixel values in the original image are not forged or altered and thus outputs the pixel values as data authenticated (S36).

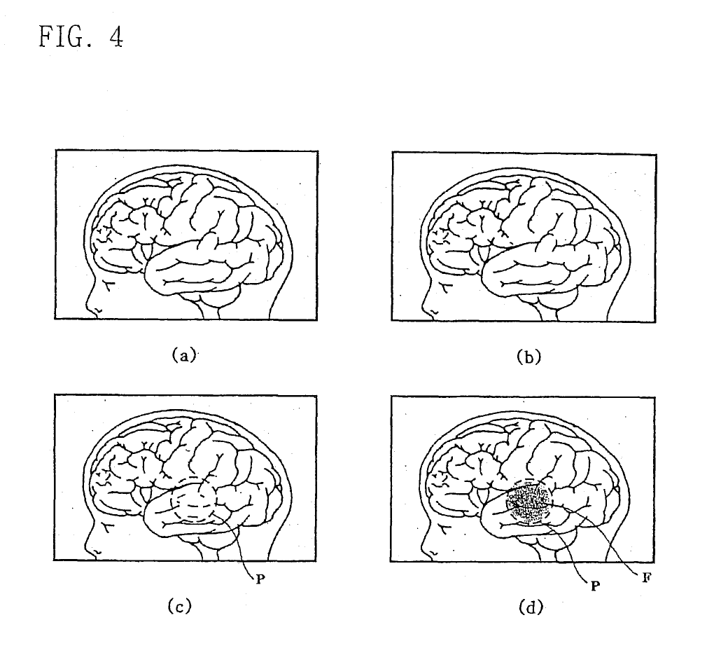

FIG. 4(a) is a schematic diagram showing digital image data acquired by the medical imaging equipment. FIG. 4(b) is a schematic diagram showing watermarked digital image data according to a predetermined embodiment of the present invention. FIG. 4(c) is a schematic diagram illustrating a forged or altered portion P in a digital image. FIG. 4(d) is a schematic diagram indicating the location F of forged or altered data detected by applying a system of the present invention to digital image data.

Accordingly, it is possible to detect whether medical image data is forged or altered by applying a digital image watermarking system of the present invention to the medical image data acquired by the medical examination equipment such as X-ray, CT, and MRI, etc. Also, the protection of important medical image data from forgery or alteration is possible by providing the resultant data of detection to the PACS.

From the foregoing, while the preferred embodiments of the invention have been described herein for purposes of illustration, it will be appreciated to those skilled in the art that various modifications may be made without deviating from the scope of the claims of the present invention.

Therefore, according to the present invention, it is possible to embed a watermark by properly adjusting the pixel values of an original image in a space region, without deteriorating the quality of the original image. Also, in the event that a subtle forgery or alteration from the outside occurs, it is possible to exactly find the area of the forged or altered data by sensitively changing the watermark key value, which was used in embedding.

Also, according to the present invention, since it is possible to detect a watermark without an original image not containing an embedded watermark, the watermark embedded is easily and promptly detectable without going through a complex watermark detecting process.

Further, according to the present invention, in the event that a medical dispute arises between a doctor and a patient, it is possible to discriminate the truth of an original medical recording (images such as X-ray, CT, MRI, electronic medical certificate, electronic prescription, etc.) Thus, the present invention is useful to settle the medical disputes and is allowed to previously prevent illegal forgery or alteration of the medical recording.

What is claimed is:

1. A method for embedding a watermark into a digital image, comprising the steps of:
(a) transforming the digital image to a predetermined format for embedding a watermark;
(b) forming a space for embedding the watermark by adjusting the pixel values of said transformed digital image to a predetermined level;
(c) generating a first watermark key to be corresponded to each pixel value of the image, in which said space for embedding is formed, based on predetermined user key data; and
(d) embedding the watermark by selectively adding or subtracting a predetermined value to or from each pixel value of said digital image adjusted to said predetermined level.

2. The method of claim 1, wherein said user key data is the private information of said user, including at least one of said user's identification number, name, inherent number, or a logo.

3. The method of claim 1, wherein said step (c) comprises the steps of:
encrypting said user key data; and
generating the first watermark key to be corresponded to each pixel value of the image, in which said space for embedment is formed, by using said encrypted user key data.

4. The method of claim 1, wherein said first watermark key represents that each pixel value of said watermarked digital image is an odd number or an even number.

5. The method of claim 4, wherein said step (d) is processed in such manner that with respect to each pixel of the image in which said space for embedment is formed, if said first watermark key represents an even number, said predetermined value is added or subtracted in order that the pixel values of the watermarked digital image can be even numbers, and if said first watermark key represents an odd number, said predetermined values are added or subtracted in order that the pixel values of the watermarked digital image can be the odd numbers.

6. The method of claim 1, wherein said first watermark key represents the statistical value of neighboring multiple pixels falling within a predetermined range around an arbitrary pixel of said watermarked digital image.

7. The method of claim 6, wherein said step (d) comprises the steps of:
calculating the statistical characteristic value of neighboring multiple pixels that fall within the predetermined range around the predetermined pixel of said digital image adjusted to said predetermined level; and
adding or subtracting a predetermined value to or from each pixel of said digital image selectively according to said first watermark key.

8. The method of claim 7, wherein said predetermined statistical characteristic is the one among the mean value, the mean value ± the standard deviation, and variance.

9. A method for detecting a watermark embedded using the method of any one of claims 1 to 8, comprising the steps of:
(e) detecting the first watermark key from the watermarked digital image according to the pixel values of said watermarked digital image;
(f) generating the second watermark key to be corresponded to the pixel value of said watermarked digital image based on said predetermined user key data used when watermarking;
(g) calculating the co-relation between said first watermark key and said second watermark key in every pixel of said watermarked digital image, and determining whether the calculated co-relation falls within a predetermined scope;
(h) determining that a watermark expected by said user is embedded into each pixel of said digital image in case that the co-relation with respect to said pixels falls within said predetermined scope, and comparing said first watermark key value with said second watermark key value in every pixel;
(i) determining that the corresponding pixel value of said digital image, into which the corresponding watermark is embedded, is forged or altered if a pair of insistent watermark keys exists as a result of said comparison; however, if not, outputting the corresponding pixel value as data authenticated; and,
(j) indicating the location of forged or altered pixel value.

10. The method of claim 9, wherein said step (g) comprises calculating the co-relation by the mathematical formula 1 below:
Corr(W_{E}, W)=real(IFFT(FFT(W)×{overscore (FFT(W)}_{E}))) (Mathematical formula 1)
wherein \overline{FFT} represents a complex conjugate of Fourier Transform (FFT) and IFFT(W) represents an inverse FFT(W).

11. An apparatus for embedding a watermark into a digital image, comprising:
transformation means for transforming the digital image to a predetermined format for embedding the watermark;
adjusting means of the pixel values for adjusting the pixel value of said transformed digital image to a predetermined level so as to form a space for embedding the watermark;
generating means of a first watermark key for generating the first watermark key to be corresponded to each pixel value of the image, into which said space for embedment is formed, based on said predetermined user key data to be inputted by a user; and
embedding means of a watermark for embedding the watermark by selectively adding or subtracting a predetermined value to or from each pixel of said digital image adjusted to said predetermined level according to said generated first watermark key.

12. The apparatus of claim 11, wherein said user key data is the private information of said user, including at least one of said user's identification number, name, inherent number, or logo.

13. The apparatus of claim 11, wherein said generating means of the first key watermark key comprises:
means for encrypting said user key data; and
means for generating said first watermark key to be corresponded to each pixel value of the image, in which said space for embedment is formed, by using said encrypted user key data.

14. The apparatus of claim 11, wherein said first watermark key represents that each pixel value of said watermarked digital image is an odd number or an even number.

15. The apparatus of claim 14, wherein with respect to each pixel of the image in which said space for embedment is embedded, if said first watermark key represents an even number, said embedding means of the watermark adds or subtracts said predetermined value in order that the pixel value of the watermarked digital image can be the even number; and if said first watermark key represents an odd number, said embedding means of the watermark adds or subtracts said predetermined value in order that the pixel values of the watermarked digital image can be odd numbers.

16. The apparatus of claim 11, wherein said first watermark key represents the statistical value of neighboring multiple pixels falling within a predetermined range around an arbitrary pixel of said watermarked digital image.

17. The apparatus of claim 16, wherein said embedding means of the watermark calculates the statistical characteristic value of neighboring multiple pixels falling within the predetermined range around the arbitrary pixel of said digital image adjusted to said predetermined level, and selectively adds or subtracts the predetermined value to or from each pixel of said digital image according to said first watermark key.

18. The apparatus of claim 17, wherein said predetermined statistic characteristic value is the one among the mean value, the mean value +the standard deviation, or variance.

19. An apparatus for detecting a watermark embedded using the apparatus of any one of claims 11 to 18, comprising:
extracting means of the watermark for extracting the first watermark key from said watermarked digital image according to the pixel value of the watermarked digital image;
generating means of a second watermark key for generating the second watermark key to be corresponded to the pixel value of said watermarked digital image based on said predetermined user key data used when watermarking;
calculating means of the co-relation for calculating the co-relation between said first watermark key and said second watermark key in every pixel unit of said watermarked digital image, and determining whether the calculated co-relation falls within the predetermined scope;
determining means for determining that a watermark expected by said user is embedded into each pixel of said digital image in case that the co-relation with respect to said pixels falls within said predetermined scope, and that the corresponding pixel value of said digital image, into which the corresponding watermark is embedded, is forged or altered in case that after comparing said first watermark key and said second watermark key in every pixel, if a pair of insistent watermark keys exists as a result of said comparison; however, if not, outputting the corresponding pixel value as data authenticated; and
indicating means for indicating the location of forged or altered pixel value.

20. The apparatus for detecting a watermark embedded using the apparatus of claim 19, wherein the co-relation is calculated by the mathematical formula 1 below:
Corr(W_{E},W)=real(IFFT(FFT(W)×{overscore (FFT(W)}_{E}))) (Mathematical formula 1)
wherein \overline{FFT} represents the complex conjugate of Fourier Transform (FFT) and IFFT(W) represents the inverse FFT(W).
